(19) United States
(12) Patent Application Publication
(10) Pub. No.: US 2026/0166663 A1
(43) Pub. Date: Jun. 18, 2026

(54) Shrink-fit gas cooling device, shrink-fit station and shrink-fit method

(71) Applicant: E. Zoller GmbH & Co. KG Einstell- und Messgeräte, Pleidelsheim (DE)

(72) Inventors: Christian PFAU, Ingersheim (DE); Alexander ZOLLER, Pleidelsheim (DE)

(21) Appl. No.: 18/574,997

(22) PCT Filed: Jun. 7, 2022
(86) PCT No.: PCT/EP2022/065397

§ 371 Date: Dec. 28, 2023

(30) Foreign Application Priority Data
Jun. 29, 2021 (DE) 10 2021 116 750.7
Dec. 21, 2021 (DE) 10 2021 134 149.3

(51) Int. Cl. B23P 11/02; H05B 6/14; H05B 6/42

(52) U.S. Cl. CPC B23P 11/027; H05B 6/14; H05B 6/42

(57) ABSTRACT

A shrink-clamping gas cooling device, in particular a shrink-clamping air cooling device, is proposed, at least for a cooling of tool units, each of which comprises at least one shrink-clamping chuck and at least one tool that is fixed in the shrink-clamping chuck, with at least one cooling place which is configured for receiving the tool unit, wherein
the shrink-clamping gas cooling device comprises at least one cooling-gas nozzle unit, which is at least configured to apply a cooling-gas flow, in particular a cooling-air flow, which forms a cooling gas knife, in particular an air knife/air blade, directed onto the tool unit that is positioned in the cooling place.

### CROSS REFERENCE TO RELATED APPLICATIONS

The present patent application is based on and incorporates herein by reference the German patent application DE 10 2021 116 750.7, filed on Jun. 29, 2021, the German follow-up patent application DE 10 2021 134 149.3, filed on Dec. 21, 2021, and the international patent application PCT/EP2022/065397, filed on Jun. 7, 2022.

### PRIOR ART

The invention concerns a shrink-clamping gas cooling device, a shrink-clamping station, a method and a shrink-clamping method.

Already a great number of cooling devices for shrink-clamping chucks have been proposed. These are usually based on contact cooling or on liquid cooling.

The objective of the invention is in particular to provide a generic device having advantageous properties with regard to a cooling, in particular of entire tool units consisting of tool and shrink-clamping chuck. The objective is achieved according to the invention.

### Advantages of the Invention

The invention is based on a shrink-clamping gas cooling device, in particular on a shrink-clamping air-cooling device, at least for a cooling of, in particular previously heated, tool units, each of which comprises at least one shrink-clamping chuck (hot-shrink chuck) and at least one tool that is fixed in the shrink-clamping chuck, with at least one cooling place which is configured for receiving the tool unit.

It is proposed that the shrink-clamping gas cooling device, in particular the shrink-clamping air-cooling device, comprises at least one cooling-gas nozzle unit, which is at least configured to apply a cooling-gas flow, in particular a cooling-air flow, which forms an air knife/air blade, directed onto the tool unit that is positioned in the cooling place. This advantageously allows achieving especially effective cooling. Advantageously, in particular in contrast to widely used cooling cuffs, a particularly even cooling is achievable, which preferably comprises an entire tool unit. Advantageously, herein not only a clamping region of a shrink-clamping chuck is cooled but also the portion of the shrink-clamping chuck below the clamping region and the tool (tool shaft) above the shrink-clamping chuck. Advantageously, a particularly favorable/intensive cooling effect is achievable by using an air knife/air blade. Advantageously, the proposed shrink-clamping gas cooling device with the cooling-gas knife enables realizing cooling times below three minutes for customary shrink-clamping chuck sizes, even already without a tempering of the cooling gas. Preferably the shrink-clamping gas cooling device is configured for a cooling of shrink-clamping chucks solely by means of a cooling gas. Preferably the cooling gas is realized as cooling air. In this way a space-saving implementation is advantageously attainable, in particular as positioning spaces for liquid or gas canisters are made unnecessary. Moreover, using a cooling-air system allows keeping a maintenance input at an advantageously low level. Alternatively, however, other cooling gases, like for example nitrogen etc., are conceivable, and it may in such a case be necessary to separate a cooling region from the ambient atmosphere. Shrink-clamping chucks have a tool receiving opening for receiving tool shafts of shaft tools. The shrink-clamping chuck expands due to heating, e. g. via induction, and the shaft tool can be laid into the tool receiving opening. During the following cooling-down and the contraction of the material that results from the cooling-down, the shrink-clamping chuck clamps the tool shaft of the shaft tool in a force-fitting, dimensionally accurate manner. For an acceleration of the shrink-clamping process and/or for a reduction of a risk of injury by hot shrink-clamping chucks, cooling apparatuses may be used. In particular, the shrink-clamping chuck forms an interface between the tool and a machine, for example a machining system. The tool is in particular realized as a shaft tool, preferably as a rotary shaft tool, for example as a drill, as a milling tool, as a profiling tool and/or as a reamer. In particular, the shrink-clamping gas cooling device is configured for a cooling of entire tool units. A cooling of shrink-clamping chucks without inserted tools by means of the shrink-clamping gas cooling device, for example after a shrinking-out of a tool out of the shrink-clamping chuck, is also possible. In particular, the cooling place comprises a holding device for holding at least one shrink-clamping chuck and/or a receiving device for receiving at least one shrink-clamping chuck. For example, the holding device and/or the receiving device may be realized as a pot, which is stationarily fixed in the shrink-clamping gas cooling device (but rotatable around an axis) or as a pot that is movable relative to a cooling-gas nozzle unit of the shrink-clamping gas cooling device, as an—in particular rotatable—spindle unit, or something like that. The tool unit is herein set into the pot and then brought into a cooling position, or the pot in which the tool unit is inserted is realized as a fix, non-removable portion of the cooling place. In particular, the tool unit is vertically aligned in the cooling place. Preferably, the tool unit is aligned in the cooling place in such a way that a tool rotation axis of the tool unit runs at least substantially parallel to the gravity direction. “Designated” or “configured” is in particular to mean specifically programmed, designed and/or equipped. By an object being provided for a certain function is in particular to be understood that the object fulfils and/or executes said certain function in at least one application state and/or operation state.

In particular, the cooling-gas nozzle unit forms an air knife/air blade. Preferably, a cooling-gas flow exiting the cooling-gas nozzle unit forms a shape of an (air) wedge, an (air) knife and/or an (air) blade. Preferably, the cooling air flow exiting the cooling-gas nozzle unit is at least substantially laminar. Preferably, the cooling air flow exiting the cooling-gas nozzle unit is flat. In particular, the shrink-clamping gas cooling device is free of spraying or wetting devices distributing a cooling liquid. Preferably the cooling-gas flow is dry. It is in particular conceivable that in order to create the cooling-gas flow, in particular the air knife, a system air, in particular pressurized system air (usually approx. 5 bar to 6 bar) of a shrink-clamping station or of a presetting and/or measuring apparatus acting together with the shrink-clamping station is used.

In particular, the cooling-gas nozzle unit is at least configured to apply a flat cooling-gas flow, which extends longitudinally in a vertical direction, in a directed manner onto the tool unit that is positioned in the cooling place.

It is further proposed that the cooling-gas nozzle unit is configured to output the cooling-gas flow that forms the cooling gas knife, in particular simultaneously, along at least 80% of an entire longitudinal extent of the cooling place, preferably along the entire longitudinal extent of the cooling place, in particular along an entire longitudinal extent of a cooling region of the cooling place, and/or along at least 80% of an entire longitudinal extent of any tool units which are regularly insertable in the cooling place, preferably along the entire longitudinal extent of the tool units. This advantageously allows achieving an especially even cooling of tool unit. Advantageously, it is in this way possible to avoid a necessity, due to subsequent cooling of insufficiently cooled-down portions of a tool unit, to subsequently correct measuring and/or presetting processes which follow a cooling process. Advantageously, this allows the tool unit to be measured lengthwise “to a μ” directly after the cooling process, totally in contrast to cooling cuffs or the like, in which regions of the tool or lower portions of the shrink-clamping chuck often have residual heat left and the tool unit hence slightly contracts afterwards (thus changing the total length). Preferably the longitudinal extent of the cooling place, of the cooling region and/or of the tool unit inserted in the cooling place extends at least substantially parallel to a vertical direction. In particular, the longitudinal extent of the cooling place, of the cooling region and/or of the tool unit inserted in the cooling place is equivalent to a vertical extent of the cooling place, of the cooling region and/or of the tool unit inserted in the cooling place. In particular, the shrink-clamping gas cooling device is configured to bring/to cool the tool unit and/or the shrink-clamping chuck to room temperature.

Furthermore, it is proposed that the cooling-gas nozzle unit forms at least one slot-shaped nozzle, wherein a slot shape of the slot-shaped nozzle is aligned at least substantially parallel to a designated installation direction of the shrink-clamping chuck, in particular of the tool unit, in the cooling place, preferably parallel to the vertical direction. This advantageously allows achieving particularly effective and/or comprehensive cooling of the shrink-clamping chuck, in particular of the entire tool unit. In particular, the slot-shaped nozzle has a longitudinal extent (vertical extent) that is substantially larger, preferably at least 5 times as large, advantageously at least 10 times as large, preferentially at least 25 times as large and especially preferentially at least 100 times as large as a transverse extent (horizontal extent) of the slot-shaped nozzle. For example, the transverse extent of the slot-shaped nozzle is less than 1 cm (e. g. 0.3 cm) while the longitudinal extent of the slot-shaped nozzle is more than 10 cm (e. g. 40 com). By a “slot shape being aligned along a direction” is in particular to be understood that a main extension direction of the slot shape, in particular of the slot-shaped nozzle, extends along this direction. A “main extension direction” of an object (in this case for example of the slot-shaped nozzle) is here in particular to mean a direction that runs parallel to a longest edge of a smallest geometric rectangular cuboid just still completely enclosing the object.

It is also proposed that the slot-shaped nozzle has at least one first (slot-shaped) nozzle opening section and at least one second (slot-shaped) nozzle opening section, wherein at least the respective cooling-gas flows exiting these two nozzle opening sections can be activated and/or deactivated independently from each other. This advantageously enables effective cooling of tool units having different shapes and/or different sizes. Advantageously, a cooling performance can be concentrated on a region in which the tool unit is located. Preferably the portion of the slot-shaped nozzle from which the cooling-gas flow is currently discharged can be lengthened or shortened, for example by connecting or disconnecting nozzle opening sections. It is in particular conceivable that the slot-shaped nozzle comprises more than two slot-shaped nozzle opening sections, which can be activated and/or deactivated in each case individually or group-wise. The nozzle opening sections may be realized as interacting but mutually separate openings or as sections of a single long, continuous opening. It is furthermore conceivable that one or several of the nozzle opening sections has/have a plurality of small bores (diameter less than 1 mm, e. g. approx. 0.5 mm). Preferably, the small bores are in this case arranged along a row or several rows forming, in a synopsis, a slot-shaped nozzle. For example, a length of such a row with small bores may be between 100 mm and 150 mm. In particular, the cooling-gas flow of the nozzle opening sections of the slot-shaped nozzle is in each case oriented at least substantially equally.

Moreover, it is proposed that the two nozzle opening sections are assigned to nozzle section elements of the slot-shaped nozzle which are realized separately from one another, in particular arranged vertically above one another. This allows attaining a high degree of flexibility. Advantageously, effective cooling of differently shaped and/or differently sized tool units is enabled. Advantageously, a cooling performance can be concentrated on a region in which the tool unit is located. In particular, the slot-shaped nozzle comprises nozzle section elements which are realized separately, preferably separable, from one another. In particular, a plurality of separately realized, preferably separable, nozzle section elements together form the slot-shaped nozzle. In particular, each of the nozzle section elements is embodied as a separate component. In particular, each of the nozzle section elements is embodied as a separate injection-molded part. Preferably the individual nozzle section elements are realized at least section-wise transparent, in particular made at least section-wise of an at least mostly transparent material.

In addition, it is proposed that the individual nozzle section elements are realized such that they are quick-action exchangeable and/or quick-action closable. This advantageously allows achieving a high degree of flexibility. Advantageously, it is moreover possible to simplify cleaning, maintenance, re-construction and/or repair. In particular, the nozzle section elements, which are realized as separate components, can be connected to the remaining part of the cooling-gas nozzle unit, in particular to a cooling gas feed line/cooling gas conveying channel of the shrink-clamping gas cooling device, via quick-action coupling, for example clips coupling (form-fit coupling/latch coupling), via magnetic coupling and/or via screw coupling. Preferably, after removal of a nozzle section element, a resulting opening to the cooling gas conveying channel can be quick-action closed by means of a simple lid or closes automatically (for example by means of a spring-loaded flap or the like) after the removal. Alternatively or additionally, something like a cap may be provided, by which individual nozzle section elements, several nozzle section elements together and/or subregions of the slot-shaped nozzle can be covered. Such a cap may be connectable to the remaining part of the cooling-gas nozzle unit and/or to the nozzle section element via quick-action coupling, for example clips coupling, magnetic coupling and/or screw coupling.

Beyond this it is proposed that the cooling-gas nozzle unit forms at least one second slot-shaped nozzle, wherein a slot shape of the second slot-shaped nozzle is aligned at least substantially parallel to the slot shape of the slot-shaped nozzle. This advantageously allows further improving a cooling effect and, for example, reducing a cooling time. It is furthermore possible to advantageously achieve more even and more comprehensive cooling of the tool units. In particular, the second slot-shaped nozzle is connected to a different cooling gas conveying channel of the shrink-clamping gas cooling device than the slot-shaped nozzle, or to a different branch of a shared cooling gas conveying channel than the slot-shaped nozzle. In particular, the shrink-clamping gas cooling device may comprise its own pressure-generating unit, e. g. a ventilator blower, which conveys the cooling gas into the cooling gas conveying channel, or may be connected to a system air, in particular pressurized system air, of a further device, for example of the shrink-clamping station or of the pre-setting and/or measuring apparatus that acts together with the shrink-clamping station. “Substantially parallel” is here in particular to mean an orientation of a direction relative to a reference direction, in particular in a plane, wherein the direction has a deviation from the reference direction that is in particular smaller than 5°, advantageously smaller than 3° and especially advantageously smaller than 1°. In particular, the second slot-shaped nozzle is arranged spaced apart from the slot-shaped nozzle by at least more than five times a maximal transverse extent, in particular horizontal extent, of the second slot-shaped nozzle.

If the second slot-shaped nozzle is arranged on a side of the cooling place opposite the slot-shaped nozzle, particularly effective, even and/or fast cooling is advantageously achievable. In particular, the slot-shaped nozzles are—in particular viewed in a top view onto the cooling place—arranged diametrally or almost diametrally opposite each other. In particular, the cooling-gas flows of the slot-shaped nozzles arranged—in particular viewed in a top view onto the cooling place—almost diametrally opposite each other, are at least slightly angled with respect to each other. Preferably, the directions of the cooling-gas flows of the slot-shaped nozzles arranged—in particular viewed in a top view onto the cooling place—almost diametrally opposite each other, are angled with respect to each other by more than 0°, preferably by more than 0.3°, and by less than 10°, preferably by less than 5°.

It is further proposed that the slot-shaped nozzle and/or the second slot-shaped nozzle are/is arranged, in particular in each case, at an end of a cooling gas conveying channel, in particular cooling air conveying channel, of the shrink-clamping gas cooling device which is curved toward the cooling place and projects from a, preferably shared, basis. In this way an operator-friendly implementation of the shrink-clamping gas cooling device, in which in particular easy access to the cooling places is enabled, is advantageously achievable. In particular, the respective cooling gas conveying channels of the slot-shaped nozzle and the second slot-shaped nozzle are curved in directions that are opposed to each other. The cooling gas conveying channels are preferably manufactured as 3D print parts.

If a tempering device is provided which is configured to temper, preferably to cool, the cooling gas, in particular the cooling air, particularly effective and fast cooling is advantageously achievable. In particular, the tempering device comprises a heat exchanger, which is at least configured to extract heat from the cooling gas before it is applied onto the tool unit or onto the shrink-clamping chuck. In particular, the tempering device, preferably the heat exchanger, comprises a cooling cycle, for example a water cycle with a water cooler. In particular, the tempering device is embodied as a cooling unit. In particular, the tempering device is configured to actively cool the cooling gas/cooling-gas flow before it hits onto the tool unit/shrink-clamping chuck that is to be cooled. It is conceivable that the tempering device can be regulated and/or activated/deactivated, for example depending on a desired cooling duration or depending on an ambient temperature, which is in particular detectable by an ambient sensor of the shrink-clamping gas cooling device.

Furthermore, it is proposed that the cooling place is configured for a rotatable support of the tool unit and/or of the shrink-clamping chuck. This advantageously allows achieving even cooling. In particular, the tool unit and/or the shrink-clamping chuck is rotated during operation of the cooling-gas nozzle unit, preferably around a designated tool rotation axis/a designated shrink-clamping chuck rotation axis. In particular, each cooling place of the shrink-clamping gas cooling device comprises a rotatable holding device, for example a spindle unit, in which the tool unit and/or the shrink-clamping chuck and/or the pot in which the tool unit is inserted are/is held during the cooling process.

Beyond this it is proposed that the cooling place is configured for a support, translatable in a horizontal plane, of the tool unit and/or of the shrink-clamping chuck. In this way particularly effective and/or even cooling is advantageously achievable, for example as the shrink-clamping chuck and/or the tool unit can be easily brought into an ideal cooling position within the cooling place. In particular, the shrink-clamping gas cooling device comprises a manually operable and/or automated translating device, which is configured for the positioning of the tool unit and/or of the shrink-clamping chuck in the horizontal plane of the cooling place. Conceivable translating devices are, for example, a conveying system or slider elements. Alternatively or additionally, it is conceivable that the shrink-clamping gas cooling device comprises a device for a positioning, in particular for a horizontal and/or vertical positioning, of the cooling-gas nozzle unit or of at least one of the slot-shaped nozzles of the cooling-gas nozzle unit.

It is also proposed that at least one slot-shaped nozzle of the cooling-gas nozzle unit, which in particular extends parallel to a central axis of the cooling place, in particular a cooling-gas flow of the slot-shaped nozzle of the cooling-gas nozzle unit, which in particular extends parallel to a central axis of the cooling place, is oriented—in particular in order to make use of the Coandă effect—offset from the central axis of the cooling place, preferably offset from a central axis of a tool unit and/or a shrink-clamping chuck which are/is insertable in the cooling place. This advantageously enables particularly effective cooling, in particular as an especially advantageous flow-around of the tool unit/the tool chuck is achieved. The collective term “Coandă effect” in particular refers to phenomena indicating a tendency of a gas beam or of a liquid flow to “run along” on a convex surface instead of separating off and moving on in the original flow direction. In particular, the cooling-gas flows of the slot-shaped nozzles are oriented relative to the cooling place, to the tool unit in the cooling place and/or to the shrink-clamping chuck in the cooling place in such a way that the cooling-gas flows tend to at least partly run along on an outer surface of the tool unit and/or of the shrink-clamping chuck (in the meaning of the Coandă effect). In particular, the slot-shaped nozzle and the second slot-shaped nozzle are both oriented offset from the central axis of the cooling place. In particular, the slot-shaped nozzle and the second slot-shaped nozzle are oriented such that they are offset differently, preferably offset in different directions, with respect to the central axis of the cooling place. In particular, the directions of the cooling-gas flows of the slot-shaped nozzle and the second slot-shaped nozzle are oriented with respect to the central axis of the cooling place such that they are conveyed past the central axis on opposite sides of the central axis. In particular, the position and/or the course of the central axis of the cooling place approximately corresponds to a position and/or a course of the tool rotation axis of the tool unit positioned regularly in the cooling place and/or to a position and/or a course of the rotation axis of the shrink-clamping chuck positioned regularly in the cooling place. In particular, the slot-shaped nozzle and/or the second slot-shaped nozzle are/is oriented offset and/or angled by an angle of at least 0.5°, preferably no more than 5°, with respect to a straight connecting line between a nozzle exit and the central axis of the cooling place. In particular, the cooling-gas flow of the slot-shaped nozzle and/or the second slot-shaped nozzle is oriented such that an average flow direction of the cooling-gas flow runs closely past the central axis of the cooling place. However, it is alternatively also conceivable that the flow direction of the cooling-gas flow is oriented directly to the central axis of the cooling place and the two slot-shaped nozzles are arranged directly opposite each other. In this way a cooling effect might be slightly reduced but production and component costs could be reduced.

It is further proposed that each of the individual nozzle section elements of the slot-shaped nozzle of the cooling-gas nozzle unit comprises at least two nozzle subregions, which are in each case—in particular in order to make use of the Coandă effect—oriented offset from the central axis of the cooling place, the two nozzle subregions of an individual nozzle section element being oriented so as to point towards different sides of the central axis of the cooling place. In this way particularly effective cooling is advantageously enabled, in particular as especially advantageous flow-around of the tool unit/tool chuck is achieved. Moreover, it is advantageously possible to keep a noise production, in particular a humming, which may be created by airflows hitting directly on each other, at an advantageously low level. In particular, the cooling gas, preferably the cooling air, exits the nozzle subregions, preferably toward the cooling place. In particular, the nozzle subregions are arranged such that they adjoin each other directly, preferably vertically above one another. In particular, the nozzle subregions are oriented in such a way that the cooling gas exiting the respective nozzle subregions runs at least partly in a circumferential direction around the tool unit that is inserted in the cooling place, wherein the circulating directions of the cooling gas exiting the two nozzle subregions are opposed to each other.

In addition, it is proposed that the shrink-clamping gas cooling device comprises a collecting unit for used cooling gas. In this way, swirling up of dust or the like is advantageously reducible. Moreover, a comparison of initial and end temperatures of the cooling gas is enabled, thus allowing advantageous controlling of the shrink-clamping gas cooling device. In particular, the collecting unit comprises at least one collecting element for each slot-shaped nozzle. In particular, the collecting element assigned to the slot-shaped nozzle is arranged opposite the slot-shaped nozzle, in particular viewed relative to the cooling place.

If the shrink-clamping gas cooling device comprises a temperature sensor unit, which is at least configured to register a temperature difference between an initial temperature of the cooling gas before a contact with the tool unit and/or the shrink-clamping chuck and an end temperature of the cooling gas after the contact with the tool unit and/or the shrink-clamping chuck, efficient controlling of the shrink-clamping gas cooling device, in particular of the tempering device, is advantageously achievable. For example, an optimal cooling time or an optimal cooling gas temperature can be set in this way. In particular, the temperature sensor unit comprises at least one temperature sensor, which is assigned to the cooling-gas nozzle unit, for determining the initial temperature. In particular, the temperature sensor unit comprises at least one temperature sensor, which is assigned to the collecting unit or to a, preferably at least partly closable, cooling region of the cooling place, for determining the end temperature. Alternatively or additionally, a temperature sensor may be provided for determining an ambient temperature/room temperature, in particular if the tempering device is dispensed with. The temperature sensor for determining an ambient temperature/room temperature may herein in particular substitute or supplement the temperature sensor for determining the initial temperature. On the basis of the measurement of the temperature difference between the room temperature and the end temperature, for example the pressure-generating unit (blower) of the shrink-clamping gas cooling device, a designated cooling duration or an activation/deactivation of the tempering device may be controlled/adjusted.

Beyond this it is proposed that the shrink-clamping gas cooling device comprises a control and/or regulation unit, which is at least configured to adjust, in particular in an automated manner, a cooling duration and/or a cooling gas temperature on the basis of a room temperature measurement, on the basis of a measurement of an end temperature of the cooling gas after contact with the tool unit, and/or on the basis of a measurement of a temperature difference between an initial temperature of the cooling gas before a contact with the tool unit and the end temperature of the cooling gas after the contact with the tool unit. This advantageously allows achieving particularly effective and/or fast cooling. By a “control and/or regulation unit” is in particular a unit with at least one control electronics part to be understood. A “control electronics part” is in particular to mean a unit with a processor unit, in particular a processor, and with a memory unit, in particular a memory chip, and with an operation program stored in the memory unit. It is herein conceivable that the cooling (blower and/or tempering device) switches off automatically upon reaching a specific end temperature. It is herein conceivable that a display device, for example an LED or the like, indicates a current end temperature or a progress of the cooling process, for example by color change or by a blinking signal, etc. It is herein conceivable that an opening/locking of a flap/door, which at least partly delimits a cooling region of the cooling place, is controlled in an automated manner, depending on the measured end temperature or depending on the measured temperature difference.

If the cooling place comprises an occupancy detection device, which is configured for an automated recognition of an occupancy situation of the cooling place, it is advantageously possible to attain a high degree of automatization and thus high user-friendliness/simple handling. In particular, the occupancy detection device comprises a contact switch, in particular a microcontact switch, which is actuated by an insertion of a tool chuck or of a pot for tool chucks into the cooling place. For example, the contact switch, in particular the microcontact switch, may be arranged at a bottom of the cooling place. Alternatively or additionally, the occupancy detection device may comprise a closure recognition of a flap/door that closes the cooling region of the cooling place.

Furthermore, it is proposed that the cooling-gas nozzle unit or at least one slot-shaped nozzle of the cooling-gas nozzle unit is realized so as to be traversable along a linear axis, which in particular extends at least substantially parallel to a designated installation direction of the shrink-clamping chuck and/or at least substantially parallel to a vertical direction. In this way an adaption of a cooling-gas flow to a shape of a tool unit/a shrink-clamping chuck is advantageously achievable. Advantageously, this allows especially effective and/or efficient cooling. In particular, the cooling-gas nozzle unit or at least one slot-shaped nozzle of the cooling-gas nozzle unit is traversable upwards and downwards along the tool unit and/or along the shrink-clamping chuck. In particular, the shrink-clamping gas cooling device comprises a rail system along which the cooling-gas nozzle unit or the slot-shaped nozzles of the cooling-gas nozzle unit is/are movable. In particular, the shrink-clamping gas cooling device comprises a, preferably electric, linear drive, which is configured to generate the movement of the cooling-gas nozzle unit or of the slot-shaped nozzles of the cooling-gas nozzle unit. In particular, at least one of the slot-shaped nozzles is fastened on a linear axis and is movable upwards and downwards via the linear drive.

It is also proposed that the shrink-clamping gas cooling device comprises at least one temperature sensor for determining an instantaneous temperature of at least one section of the shrink-clamping chuck positioned in the cooling place or of the tool unit positioned in the cooling place. This advantageously enables efficient controlling of the shrink-clamping gas cooling device. In particular, the temperature sensor is realized as a contactless temperature sensor. The temperature sensor may be part of the aforementioned temperature sensor unit or may be realized separately therefrom.

If the temperature sensor can be moved along with the linearly movable cooling-gas nozzle unit or with the linearly movable slot-shaped nozzle, it is advantageously possible to further improve a cooling process, in particular with regard to efficiency. In particular, the temperature sensor is configured to carry out a search run in which the tool unit that is to be cooled/the shrink-clamping chuck that is to be cooled is traversed from above downwards or from below upwards, with the local instantaneous temperatures of the tool unit/the shrink-clamping chuck being recorded at all levels.

If herein the temperature sensor is configured to detect a position of a hot section at least of the shrink-clamping chuck or of the tool unit, it is advantageously possible to determine the region of the shrink-clamping chuck or of the tool unit which requires cooling.

In this context, it is proposed that a positioning of a linearly movable cooling-gas nozzle unit or of a linearly movable slot-shaped nozzle or an activation of one or several nozzle opening sections of the slot-shaped nozzle is controlled depending on the determined position of the hot section of the shrink-clamping chuck or of the tool unit identified by the temperature sensor, in particular with the assistance of the control and/or regulation unit, which receives temperature measurement signals from the temperature sensor/s and converts them into controlling commands for the shrink-clamping gas cooling device, for example for the cooling-gas nozzle unit of the shrink-clamping gas cooling device or for the drive of the shrink-clamping gas cooling device. This advantageously allows achieving especially high cooling efficiency and/or cooling effectivity. For example, the linearly movable cooling-gas nozzle unit or the linearly movable slot-shaped nozzle stops at a level of a hot/hottest region of the tool unit/of the shrink-clamping chuck, and the cooling-gas flow is activated

Alternatively or additionally, it would also be conceivable that the shrink-clamping gas cooling device comprises a plurality of temperature sensors, which are arranged vertically above one another and which are configured to record a temperature profile of the tool unit/of the shrink-clamping chuck in the cooling place. It would then be possible, depending on the temperature profile obtained, that a certain height (the height of the hottest region) of the tool unit/of the shrink-clamping chuck is traveled to by the linearly movable cooling-gas nozzle unit or by the linearly movable slot-shaped nozzle, or that a portion of an immobile cooling-gas nozzle unit that overlaps with a specific height (the hottest region) of the tool unit/of the shrink-clamping chuck could be activated while, if applicable, other parts of the cooling-gas nozzle unit which are situated outside the heated regions of the tool unit/of the shrink-clamping chuck may remain in a deactivated state. Furthermore, it is alternatively also conceivable that only the temperature sensor is supported in a linearly movable manner and the afore-described overlapping portion of the immobile cooling-gas nozzle unit is activated by the afore-described search run. For this purpose, the shrink-clamping gas cooling device preferably comprises a valve system via which nozzle opening sections of slot-shaped nozzles can be respectively connected or disconnected.

Beyond this it is proposed that the shrink-clamping gas cooling device comprises an illuminated display, which is assigned to the cooling-gas nozzle unit and is preferably arranged on the cooling-gas nozzle unit, for indicating a progress and/or a state of a current cooling process of a tool unit that is situated in a cooling place. This advantageously allows achieving high efficiency of the cooling process, in particular as the operator knows immediately when the cooling process is finished and when a new tool unit may be inserted into the cooling place. Moreover, safety is advantageously augmentable, in particular as it is possible to perceive if a tool unit is still hot. In particular, the illuminated display comprises at least one LED. Preferably the illuminated display is realized as a color-change display, for example with several differently-colored LEDs or with an LED capable of changing color. In particular, the illuminated display is arranged on the cooling-gas nozzle unit, preferably on at least one of the slot-shaped nozzles or on one of the cooling gas conveying channels. For example, the illuminated display glows red while the cooling process is running, respectively as long as the tool unit has not yet cooled down sufficiently. For example, the illuminated display glows blue as soon as the cooling process is finished, respectively as soon as the tool unit can be taken out of the cooling place.

Herein it is further proposed that the illuminated display is arranged in an interior of a cooling gas conveying channel of the cooling-gas nozzle unit and is configured to illuminate/make glow at least one slot-shaped nozzle, in particular at least one, preferably at least section-wise transparent, nozzle section element of the slot-shaped nozzle. This advantageously enables substantial heightening of user-friendliness. It is advantageously possible to make easily and clearly perceivable which cooling places are currently in a cooling process and which are not. In particular, the illuminated display is arranged in the interior of the cooling gas conveying channel of the cooling-gas nozzle unit in such a way that the light leaves an exit of the cooling gas conveying channel and is coupled into the slot-shaped nozzle/the nozzle section elements. Preferably each of the nozzle section elements is provided with its own illuminated display. In particular, the material of the transparent nozzle section elements comprises dispersion centers making sure that the light coupled into the nozzle section elements illuminates a largest possible portion of the nozzle section elements, preferably colors them in the illumination color of the illumination agent of the illuminated display.

Furthermore, a shrink-clamping station with the shrink-clamping gas cooling device is proposed. This allows achieving advantageous properties with regard to the shrink-clamping process. In particular, the shrink-clamping apparatus is realized as a table device and/or as a work bench. In particular, the shrink-clamping station is configured for an assembly and/or disassembly of tool units which are implemented from a tool and from a shrink-clamping chuck.

If the shrink-clamping station comprises a plurality of cooling places which are separately loadable, in particular with tool units and/or with shrink-clamping chucks, high efficiency and/or high throughput are/is advantageously achievable, in particular as the heating process is usually realized faster than the cooling process. In particular, each cooling place of the plurality of cooling places comprises a shrink-clamping gas cooling device. It is conceivable that all shrink-clamping gas cooling devices are equipped with a shared cooling gas supply, for example a shared pressurized-air connection, for example a pressurized-air connection to a system air of a presetting and/or measuring apparatus.

It is also proposed that the shrink-clamping station comprises an induction heating unit. This advantageously allows achieving a high level of functional integration.

Furthermore, a method for a cooling of tool units and/or shrink-clamping chucks with at least one shrink-clamping gas cooling device is proposed. This advantageously allows achieving particularly effective cooling.

In addition, it is proposed that in at least one method step, at least on the basis of a composition of a tool unit that is currently to be cooled/on the basis of a type of a shrink-clamping chuck that is currently to be cooled, and/or on the basis of shrink-clamping parameters used in a preceding shrink-clamping process of the tool unit that is currently to be cooled or of the shrink-clamping chuck that is currently to be cooled, an optimal cooling time is determined, preferably in an automated manner. This advantageously allows achieving particularly high efficiency and/or particularly high throughput. In particular, during a transfer of the tool unit and/or of the shrink-clamping chuck to the shrink-clamping station, the tool unit and/or the shrink-clamping chuck is identified by manual input or by reading out of an identifier or the like. In particular, after identifying the tool unit and/or the shrink-clamping chuck, cooling parameters, like for example cooling time, cooling intensity, cooling temperature, etc., which are suitable for the tool unit/the shrink-clamping chuck, are read out from a database, for example a central database or from a database of the shrink-clamping station. Alternatively, it is also conceivable that the cooling parameters are stored in a component of the tool unit and/or of the shrink-clamping chuck, for example a chip, and can be read out by the shrink-clamping station. It is moreover conceivable that the tool units and/or the shrink-clamping chucks are taught in the shrink-clamping station. For this a temperature is measured manually or automatically after a specific cooling time in order to determine the optimal cooling time for the respective tool unit and/or the respective shrink-clamping chuck. The cooling parameters, e. g, the cooling time, of the tool unit and/or of the shrink-clamping chuck which are necessary for reaching a room temperature, are stored in the shrink-clamping station or are transmitted to a central or local server. If an assembly or disassembly of the same tool unit and/or of the same shrink-clamping chuck is carried out once again, the necessary cooling parameters, like for example the necessary cooling time, are read out once more and are then applied in the cooling process. Cooling parameters which have already been determined may advantageously be transferred to at least substantially identical tool units or shrink-clamping chucks, such that a respective calibration is not necessary for each individual tool unit and/or each individual shrink-clamping chuck.

Furthermore, a shrink-clamping method for a clamping-in of tools into shrink-clamping chucks and/or for a removal of tools from shrink-clamping chucks is proposed, wherein in one method step the shrink-clamping chuck is heated such that a receiving space of the shrink-clamping chuck expands, wherein in a further method step the tool is inserted into the expanded receiving space of the shrink-clamping chuck so as to form a tool unit, or is removed from the expanded receiving space of the shrink-clamping chuck, and wherein in a further method step the hot tool unit or the hot shrink-clamping chuck is inserted into a cooling place of a shrink-clamping station, and wherein in a further method step the tool unit, in particular the entire tool unit, or the shrink-clamping chuck, in particular the entire shrink-clamping chuck, is cooled by a cooling-gas flow, in particular cooling-air flow, which forms a cooling gas knife, in particular an air knife/air blade, and which is directed to the tool unit positioned in the cooling place or to the shrink-clamping chuck positioned in the cooling place. This advantageously allows achieving particularly effective cooling.

The shrink-clamping gas cooling device according to the invention, the shrink-clamping station according to the invention and the methods according to the invention shall herein not be limited to the application and implementation described above. In particular, in order to fulfil a functionality that is described here, the shrink-clamping gas cooling device according to the invention, the shrink-clamping station according to the invention and the methods according to the invention may comprise a number of individual method steps, elements, components and units that differs from a number given here.

### DRAWINGS

Further advantages will become apparent from the following description of the drawings. In the drawings five exemplary embodiments of the invention are illustrated. The drawings, the description and the claims contain a plurality of features in combination. Someone skilled in the art will purposefully also consider the features individually and will find further expedient combinations.

It is shown in:
a schematic perspective illustration of a shrink-clamping station with a shrink-clamping gas cooling device,
a schematic view of the shrink-clamping gas cooling device,
a schematic top view onto a cutout of the shrink-clamping station with the shrink-clamping gas cooling device,
a schematic front view of a cutout of the shrink-clamping station with the shrink-clamping gas cooling device in the region of a cooling place of the shrink-clamping gas cooling device,
a schematic flowchart of a shrink-clamping method,
a schematic front view of a cutout of an alternative shrink-clamping station with an alternative shrink-clamping gas cooling device in the region of a cooling place of the alternative shrink-clamping gas cooling device,
a schematic view of a further alternative shrink-clamping gas cooling device,
a schematic top view onto a cutout of the further alternative shrink-clamping station with the further alternative shrink-clamping gas cooling device,

FIG. 9a a schematic view of a slot-shaped nozzle of a cooling-gas nozzle unit of a second alternative shrink-clamping gas cooling device,

FIG. 9b a schematic view of a slot-shaped nozzle of a cooling-gas nozzle unit of the shrink-clamping gas cooling device,

FIG. 10 a schematic view of a third alternative shrink-clamping gas cooling device,

FIG. 11 a schematic horizontal sectional view through the third alternative shrink-clamping gas cooling device, and

FIG. 12 a schematic detailed view of the third alternative shrink-clamping gas cooling device with quick-action-wise exchangeable nozzle section elements.

### DESCRIPTION OF THE EXEMPLARY EMBODIMENTS

FIG. 1 shows a schematic perspective illustration of a shrink-clamping station 66a. The shrink-clamping station 66a comprises a heating station 88a. In the heating station 88a tool receiving openings of shrink-clamping chucks 12a (cf. inter al. FIG. 2) are expanded by heating, such that tools 14a can be inserted into the tool receiving openings. The shrink-clamping station 66a, in particular the heating station 88a, comprises an induction heating unit 70a. The induction heating unit 70a is realized as an induction coil unit that can be put upon a shrink-clamping chuck 12a. The induction heating unit 70a is linearly traversable in a vertical direction.

The shrink-clamping station 66a comprises a cooling station 90a. In the cooling station 90a the tool receiving openings of the shrink-clamping chucks 12a are re-shrunk by cooling, such that the tools 14a which were inserted in the tool receiving openings are fastened therein in a force-fitting manner. The cooling station 90a comprises a plurality of cooling places 16a, 68a, which can be separately loaded with tool units 10a and/or with shrink-clamping chucks 12a. In the exemplary embodiment shown in FIG. 1, the cooling station 90a comprises three cooling places 16a, 68a. Of course, more or fewer than three cooling places 16a, 68a are conceivable. Shrink-clamping chucks 12a heated in the heating station 88a are conveyed further to the cooling station 90a after insertion of a tool 14a or after removal of a tool 14a. The shrink-clamping station 66a comprises a control and/or regulation unit 56a. The control and/or regulation unit 56a is configured for a controlling and/or for a regulation of a heating process of the heating station 88a and/or of a cooling process of the cooling station 90a. The shrink-clamping station 66a comprises a display device 84a at least for outputting information concerning the heating process or the cooling process. The shrink-clamping station 66a comprises a shrink-clamping gas cooling device 44a. The shrink-clamping gas cooling device 44a is embodied as an air cooling device. The shrink-clamping gas cooling device 44a has in each cooling place 16a, 68a a contact switch 140a, which is configured to capture a presence of a tool unit 10a in the respective cooling place 16a, 68a.

FIG. 2 shows a schematic view of the shrink-clamping gas cooling device 44a. The shrink-clamping gas cooling device 44a is at least configured for a cooling of tool units 10a, each of which comprises a shrink-clamping chuck 12a and a tool 14a that is fastened in the shrink-clamping chuck 12a. The shrink-clamping gas cooling device 44a comprises the cooling place 16a. The shrink-clamping gas cooling device 44a may also comprise further cooling places 68a. The cooling places 16a, 68a are configured for receiving the tool unit 10a. The cooling places 16a, 68a shown by way of example are configured for placing respectively one pot 94a therein. The pot 94a is configured for an upright holding of tool units 10a and/or shrink-clamping chucks 12a. The cooling places 16a, 68a are configured for a rotatable support of the tool units 10a and/or shrink-clamping chucks 12a introduced therein. In the exemplary embodiment shown in FIG. 2, the pot 94a has a circumferential toothing 96a, which is configured to mesh with a further driven gear wheel of a drive. In addition, the cooling places 16a, 68a are configured for a support of the tool units 10a and/or of the shrink-clamping chucks 12a, said support being translatable in a horizontal plane. In the exemplary embodiment of FIG. 2 this is realized by a conveying system (not explicitly shown) which the pot 94a can be placed on.

The shrink-clamping gas cooling device 44a comprises a cooling-gas nozzle unit 18a. The cooling-gas nozzle unit 18a is configured to create a cooling-gas flow 20a. The cooling-gas flow 20a is realized as a cooling-air flow. The cooling-gas flow 20a is configured for cooling down a previously heated region of a shrink-clamping chuck 12a. The cooling-gas nozzle unit 18a is configured to apply the cooling-gas flow 20a in a directed manner onto the tool unit 10a which is positioned in the cooling place 16a.

The cooling-gas flow 20a forms a cooling gas knife. The cooling-air flow forms an air knife/air blade. The cooling-air flow that forms the air knife/air blade is realized as something like a flat air curtain which forms, at least at a nozzle exit point, an at least mostly laminar airflow. The cooling-gas nozzle unit 18a moreover forms one or several air knife nozzles/air blade nozzles.

The cooling-gas nozzle unit 18a is configured for outputting the cooling-gas flow 20a that forms the cooling gas knife simultaneously along at least 80% of an entire longitudinal extent 22a of a cooling region 98a of the cooling place 16a, 68a. The cooling region 98a can be closed at least partly by means of a flap 128a of the shrink-clamping station 66a (cf. FIG. 1). Alternatively, however, the flap 128a may be dispensed with. The cooling-gas nozzle unit 20a is configured for outputting the cooling-gas flow 20a that forms the cooling gas knife simultaneously along at least 80% of an entire longitudinal extent 24a of any tool units 10a and/or shrink-clamping chucks 12a inserted regularly into the cooling place 16a, 68a. The cooling-gas nozzle unit 18a is configured for a simultaneous cooling of a large portion of the respective tool unit 10a positioned in the cooling place 16a, 68a. The cooling-gas nozzle unit 18a is configured for a simultaneous cooling of the entire respective tool unit 10a positioned in the cooling place 16a, 68a. Alternatively, the cooling-gas nozzle unit 18a may be configured for a simultaneous cooling of an entire (but limited) region, heated in a preceding heating process, of the respective tool unit 10a respectively positioned in the cooling place 16a, 68a. In the cooling region 98a of the cooling place 16a, 68a, tool units 10a having different sizes and different compositions and/or shrink-clamping chucks 12a having different sizes are insertable. In the cooling region 98a of the cooling place 16a, 68a, tool units 10a having different sizes and different compositions and/or shrink-clamping chucks 12a having different sizes can be cooled.

The cooling-gas nozzle unit 18a forms a slot-shaped nozzle 26a. The cooling-gas nozzle unit 18a forms a second slot-shaped nozzle 38a. A slot shape 30a of the slot-shaped nozzle 26a or of the second slot-shaped nozzle 38a is aligned parallel to a designated installation direction 28a of the shrink-clamping chuck 12a in the cooling place 16a. The slot shape 30a of the slot-shaped nozzle 26a or of the second slot-shaped nozzle 38a is aligned parallel to a vertical direction. The air knife/air blade is aligned parallel to the vertical direction and/or parallel to the designated installation direction 28a of the shrink-clamping chuck 12a in the cooling place 16a. The slot-shape 30a of the second slot-shaped nozzle 38a is oriented parallel to the slot shape 30a of the slot-shaped nozzle 26a. The second slot-shaped nozzle 38a is arranged on a side of the cooling place 16a, 68a that is situated opposite the slot-shaped nozzle 26a. The slot-shaped nozzles 26a, 38a are oriented towards the tool unit 10a from different sides.

The shrink-clamping gas cooling device 44a comprises a tempering device 46a. The tempering device 46a is configured for a cooling of cooling gas 48a/cooling air. The tempering device 46a comprises a cooling apparatus 100a. The cooling apparatus 100a is configured for cooling the cooling gas 48a/cooling air down to a value (e. g. to 10° C.) below a room temperature/an ambient temperature. The shrink-clamping gas cooling device 44a comprises a radial blower 102a. The radial blower 102a is configured to generate a pressure with which the cooling gas 48a/the cooling air is pushed out of the slot-shaped nozzles 26a, 38a. Alternatively, the radial blower 102a may also be replaced by a connection to a further external or internal pressurized-air system. Moreover, optionally a heat exchanger 104a may be provided.

FIG. 3 schematically shows a top view onto a section of the shrink-clamping station 66a with the shrink-clamping gas cooling device 44a in the region of the cooling place 16a. The shrink-clamping gas cooling device 44a comprises a basis 40a. The shrink-clamping gas cooling device 44a comprises a first cooling gas conveying channel 42a. The shrink-clamping gas cooling device 44a comprises a second cooling gas conveying channel 106a. The slot-shaped nozzle 26a is formed on a cooling-place-side end 108a of the first cooling gas conveying channel 42a. The second slot-shaped nozzle 38a is formed on a cooling-place-side end 110a of the second cooling gas conveying channel 106a. The first cooling gas conveying channel 42a is curved toward the cooling place 16a. The first cooling gas conveying channel 42a projects from the basis 40a toward the cooling place 16a. The second cooling gas conveying channel 106a is curved toward the cooling place 16a. The second cooling gas conveying channel 106a projects from the basis 40a toward the cooling place 16a. The basis 40a forms a shared basis 40a for the two cooling gas conveying channels 42a, 106a.

For making use of the Coanda effect, the slot-shaped nozzle 26a of the cooling-gas nozzle unit 18a is oriented offset from a central axis 50a of the cooling place 16a. For making use of the Coanda effect, the second slot-shaped nozzle 38a of the cooling-gas nozzle unit 18a is oriented offset from the central axis 50a of the cooling place 16a. The slot-shaped nozzles 26a, 38a are oriented offset in opposed directions from the central axis 50a of the cooling place 16a. The slot-shaped nozzle 26a is oriented offset slightly inwards in a direction pointing to the shared basis 40a. The second slot-shaped nozzle 38a is oriented offset slightly outwards in a direction pointing away from the shared basis 40a. Alternatively, it is also conceivable that the slot-shaped nozzles 26a, 38a are not oriented offset from each other but are oriented such that they point directly toward each other (not illustrated).

The shrink-clamping gas cooling device 44a comprises an illuminated display 138a. The illuminated display 138a is assigned to the cooling-gas nozzle unit 18a. The illuminated display 138a is configured to indicate a progress and/or a state of a current cooling process of a tool unit 10a that is situated in a cooling place 16a. The illuminated display 138a comprises at least one LED. The illuminated display 138a is arranged in an interior of one of the cooling gas conveying channels 42a, 106a. The illuminated display 138a is configured to illuminate/make glow at least one of the slot-shaped nozzles 26a, 38a. For this purpose, at least the cooling-place-side end 108a, 110a of the respective cooling gas conveying channel 42a, 106a is realized at least partially transparent.

FIG. 4 schematically shows a front view of a section of the shrink-clamping station 66a with the shrink-clamping gas cooling device 44a in the region of the cooling place 16a. The cooling place 16a comprises an occupancy detection device 58a. The occupancy detection device 58a is configured for an automated recognition of an occupancy situation of the cooling place 16a. By way of example, the occupancy detection device 58a is embodied as a pressure switch which is activated by a self-weight of the shrink-clamping chuck 12a.

The slot-shaped nozzles 26a, 38a of the cooling-gas nozzle unit 18a are traversable along a linear axis 62a. The linear axis 62a runs parallel to the designated installation direction 28a of the shrink-clamping chuck 12a in the cooling place 16a. The linear axis 62a runs parallel to the vertical axis. The shrink-clamping gas cooling device 44a comprises a rail system 114a (not shown in detail) for guiding the movement of the slot-shaped nozzles 26a, 38a. The shrink-clamping gas cooling device 44a comprises a drive unit 112a for generating the linear movement of the slot-shaped nozzles 26a, 38a. By the movement along the linear axis 62a the slot-shaped nozzles 26a, 38a can be oriented precisely relative to the respective tool unit 10a that is to be cooled, for example relative to the length of the tool unit 10a that is to be cooled or to its respective position in the receiving space of the shrink-clamping chuck 12a.

The shrink-clamping gas cooling device 44a comprises a temperature sensor 64a. The temperature sensor 64a is configured for determining an instantaneous temperature at least of a section of a shrink-clamping chuck 12a that is positioned in the cooling place 16a. The temperature sensor 64a is configured for determining an instantaneous temperature at least of a section of a tool unit 10a that is positioned in the cooling place 16a. The temperature sensor 64a is realized as a contactless temperature probe, for example as an infrared temperature sensor. Alternatively, further types of temperature probes are possible. The temperature sensor 64a is traversable along a linear axis, in particular along the same linear axis 62a as the slot-shaped nozzles 26a, 38a or along a separate linear axis. The temperature sensor 64a is traversable in a vertical direction. Preferably the temperature sensor 64a can be moved along with the linearly movable cooling-gas nozzle unit 18a or with the linearly movable slot-shaped nozzle 26a, 38a. The movement along the linear axis 62a enables the temperature sensor 64a to create a temperature profile of the tool unit 10a in the cooling place 16a or of the shrink-clamping chuck 12a in the cooling place 16a. Alternatively, it is conceivable that the shrink-clamping gas cooling device 44a comprises, for determining the temperature profiles, several immovably fixed temperature sensors monitoring the cooling region 98a along the vertical direction. The temperature sensor 64a is configured to detect a position of a hot section of the shrink-clamping chuck 12a or of the tool unit 10a, in particular on the basis of the obtained temperature profile of the tool unit 10a or of the shrink-clamping chuck 12a. The control and/or regulation unit 56a is configured for controlling a positioning of the linearly movable cooling-gas nozzle unit 18a or of the linearly movable slot-shaped nozzles 26a, 38a depending on the determined position of the hot section of the shrink-clamping chuck 12a or of the tool unit 10a, which was identified by the temperature sensor 64a. The control and/or regulation unit 56a is configured to position the cooling-gas nozzle unit 18a or the linearly movable slot-shaped nozzles 26a, 38a in such a way that the identified hot section of the shrink-clamping chuck 12a or of the tool unit 10a in the cooling place 16a is optimally cooled when the cooling-gas flow 20a is activated. The control and/or regulation unit 56a is configured for controlling an activation of one or several separately actuatable nozzle opening sections 32a, 34a (cf. FIG. 6) of the slot-shaped nozzle 26a, 38a.

FIG. 5 shows a schematic flowchart of a shrink-clamping method for a clamping-in of tools 14a into shrink-clamping chucks 12a and/or for a removal of tools 14a from shrink-clamping chucks 12a, comprising a method for a cooling of tool units 10a and/or of shrink-clamping chucks 12a by the shrink-clamping gas cooling device 44a. In at least one method step 74a the shrink-clamping chuck 12a is heated, such that a receiving space of the shrink-clamping chuck 12a expands. In the method step 74a the induction heating unit 70a is put over the shrink-clamping chuck 12a. An induction-magnetic field generated by the induction heating unit 70a induces a heating of the shrink-clamping chuck 12a at least in the region of the shrink-clamping chuck 12a situated around the receiving space. In a further method step 76a the tool 14a is inserted into the expanded receiving space of the shrink-clamping chuck 12a or is removed from the expanded receiving space of the shrink-clamping chuck 12a. Preferably the insertion and the removal are carried out by an automated robot gripper. However, manual insertion and removal are also conceivable. In a further method step 78a the hot tool unit 10a or the hot shrink-clamping chuck 12a is inserted into one of the cooling places 16a, 68a of the shrink-clamping station 66a. In the method step 78a the presence of the tool unit 10a is determined by means of the contact switch 140a and is preferably transmitted to the control and/or regulation unit 56a. In at least one further method step 72a, an optimal cooling time is determined automatedly, at least on the basis of a composition of the tool unit 10a that is currently to be cooled/of the shrink-clamping chuck 12a that is currently to be cooled, or on the basis of shrink-clamping parameters which were used in a preceding shrink-clamping process of the tool unit 10a that is currently to be cooled/of the shrink-clamping chuck 12a that is currently to be cooled. In a further or alternative method step 126a, the cooling duration and/or the cooling performance are/is flexibly adjusted depending on measurement data of a temperature sensor unit 54a, which in particular determines the ambient temperature, the temperature of the non-used cooling gas 48a or the temperature of the used cooling gas 48a. In the method step 72a or in the method step 126a, the illuminated display 138a is activated. The illuminated display 138a outputs a signal indicating that the tool unit 10a is hot (e. g. a red light). It is also conceivable that a temperature profile of the heated shrink-clamping chuck 12a or of the heated tool unit 10a is obtained in the method step 126a and that, on the basis of this temperature profile, a position of the cooling-gas nozzle unit 18a and/or of the slot-shaped nozzle/s 26a, 38a is adjusted and/or a portion of the cooling-gas nozzle unit 18a is selected for an activation/an output of cooling gas 48a while another subregion of the cooling-gas nozzle unit 18a remains deactivated and does not output cooling gas 48a. In a further method step 80a, the tool unit 10a or the shrink-clamping chuck 12a is cooled by a cooling-gas flow 20a, which forms a cooling gas knife, in particular an air knife/air blade, and which is directed to the tool unit 10a positioned in the cooling place 16a or to the shrink-clamping chuck 12a positioned in the cooling place 16a. The method step 80a may be started automatically by an activation of the contact switch 140a. In the method step 80a, the optimal cooling times determined in the method step 72a are used. In a further method step 122a, the cooling process is stopped as soon as the tool unit 10a and/or the shrink-clamping chuck 12a have/has reached the room temperature. In the method step 122a the termination of the cooling process is indicated to an operator by a lighting element (LED) that is assigned to the respective cooling place 16a or by indicating an opening of the flap 128a that closes the cooling region 98a. In the method step 122a, an output signal of the illuminated display 138a changes (jumping, for example, from red to blue or green). In at least one further method step 124a, the completely cooled tool unit 10a with the tool 14a is measured (to a u) lengthwise by a presetting and/or measuring apparatus (not shown).

In FIGS. 6 to 9a and 10 to 12, four further exemplary embodiments of the invention are shown. The following descriptions and the drawings are limited essentially to the differences between the exemplary embodiments, wherein with regard to components having the same denomination, in particular to components having the same reference numerals, principally the drawings and/or the description of the other exemplary embodiments, in particular of FIGS. 1 to 5 and 9b, may be referred to. In order to distinguish between the exemplary embodiments, the letter a has been added to the reference numerals of the exemplary embodiment in FIGS. 1 to 5 and 9b. In the exemplary embodiments of FIGS. 6 to 9a and 10 to 12 the letter a has been substituted by the letters b to e.

FIG. 6 schematically shows a front view of a section of an alternative shrink-clamping station 66b with an alternative shrink-clamping gas cooling device 44b in the region of a cooling place 16b of the shrink-clamping gas cooling device 44b. The shrink-clamping gas cooling device 44b comprises a cooling-gas nozzle unit 18b. The cooling-gas nozzle unit 18b forms a slot-shaped nozzle 26b. The slot-shaped nozzle 26b comprises a first nozzle opening section 32b. The slot-shaped nozzle 26b comprises a second nozzle opening section 34b. The cooling-gas nozzle unit 18b is configured to create cooling-gas flows 20b, 36b. The cooling-gas flows 20b, 36b respectively form a cooling gas knife. The respective cooling-gas flows 20b, 36b exiting the two nozzle opening sections 32b, 34b can be activated and/or deactivated independently from each other. It is conceivable that the slot-shaped nozzle 26b comprises more than two nozzle opening sections with cooling-gas flows which can in each case be activated and/or deactivated independently from each other.

FIG. 7 shows a schematic view of a further alternative shrink-clamping gas cooling device 44c. The further alternative shrink-clamping gas cooling device 44c comprises a cooling-gas nozzle unit 18c. The cooling-gas nozzle unit 18c forms a slot-shaped nozzle 26c. The cooling-gas nozzle unit 18c is configured to create a cooling-gas flow 20c which forms a cooling gas knife. The cooling-gas flow 20c is configured for a cooling of a previously heated region of a shrink-clamping chuck 12c. The cooling-gas nozzle unit 18c is configured to apply the cooling-gas flow 20c in a directed manner to a tool unit 10c that is positioned in a cooling place 16c of the further alternative shrink-clamping gas cooling device 44c. The further alternative shrink-clamping gas cooling device 44c comprises a collecting unit 52c for used cooling gas 48c. The collecting unit 52c is arranged on a side of the cooling place 16c opposite the slot-shaped nozzle 26c.

FIG. 8 shows schematically a top view onto a section of a further alternative shrink-clamping station 66c with the further alternative shrink-clamping gas cooling device 44c in the region of the cooling place 16c. The further alternative shrink-clamping gas cooling device 44c forms a cooling-gas cycle 116c. In the case shown exemplarily in FIG. 8, the further alternative shrink-clamping gas cooling device 44c comprises a tempering device 46c with a heat exchanger 104c. The heat exchanger 104c is configured to extract heat from the cooling gas 48c collected by the collecting unit 52c. In the case shown exemplarily in FIG. 8, the further alternative shrink-clamping gas cooling device 44c comprises a radial blower 102c. The cooling gas 48c cooled by the heat exchanger 104c is fed once more to the cooling-gas nozzle unit 18c, in particular to the tool unit cooling, via the radial blower 102c.

The shrink-clamping gas cooling device 44c comprises a temperature sensor unit 54c. The temperature sensor unit 54c is configured to register a temperature difference between an initial temperature of the cooling gas 48c before a contact with the tool unit 10c that is to be cooled and/or with a shrink-clamping chuck 12c that is to be cooled and an end temperature of the cooling gas 48c after the contact with the tool unit 10c that is to be cooled and/or with the shrink-clamping chuck 12c that is to be cooled. The temperature sensor unit 54c comprises a first temperature sensor 64c. The first temperature sensor 64c is assigned to the cooling-gas nozzle unit 18c. The first temperature sensor 64c is configured to detect the initial temperature of the cooling gas 48c. The temperature sensor unit 54c comprises a second temperature sensor 118c. The second temperature sensor 118c is assigned to the collecting unit 52c. The second temperature sensor 118c is configured to detect the end temperature of the cooling gas 48c. The temperature sensor unit 54c optionally comprises a third temperature sensor 120c. The third temperature sensor 120c is arranged outside the cooling-gas cycle 116c. The third temperature sensor 120c is configured to detect a room temperature/an ambient temperature around the shrink-clamping station 66c. Alternatively it is conceivable that the first temperature sensor 64c is configured for determining the room temperature, in particular if ambient air is used to create the cooling-gas flow 20c that forms the cooling gas knife.

The further alternative shrink-clamping gas cooling device 44c comprises a control and/or regulation unit 56c. The control and/or regulation unit 56c is configured to adjust in an automated manner a cooling duration and/or a cooling gas temperature on the basis of the room temperature measurement, on the basis of the measurement of the end temperature of the cooling gas 48c after the contact with the tool unit 10c that is to be cooled and/or with the shrink-clamping chuck 12c that is to be cooled, or on the basis of the measurement of the temperature difference between the initial temperature of the cooling gas 48c before the contact with the tool unit 10c that is to be cooled or with the shrink-clamping chuck 12c that is to be cooled and the end temperature of the cooling gas 48c after the contact with the tool unit 10c that is to be cooled or with the shrink-clamping chuck 12c that is to be cooled. If there is an increase of the measured room temperature or of the measured temperature difference, for example, a cooling duration is increased by the control and/or regulation unit 56c, an intensity of the cooling-gas flow 20c is increased by the control and/or regulation unit 56c or a cooling-gas temperature is reduced by the control and/or regulation unit 56c.

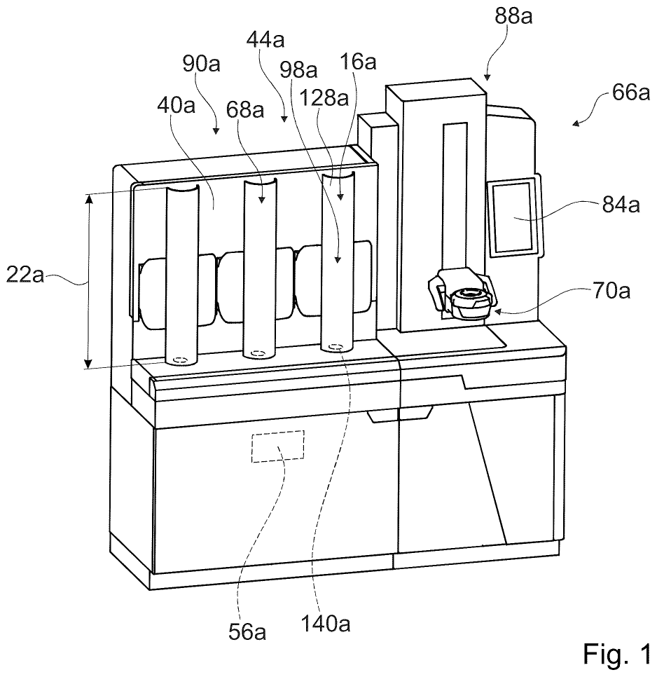

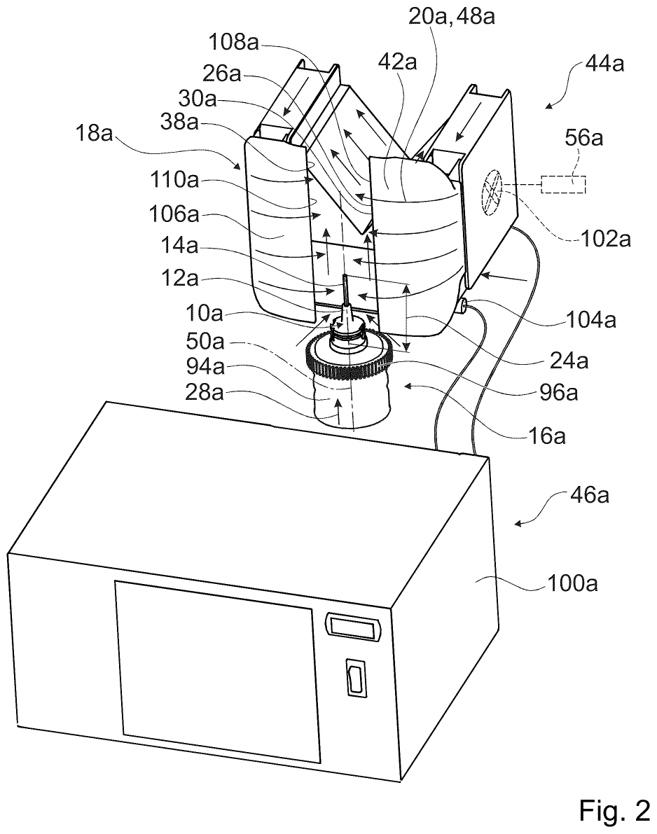

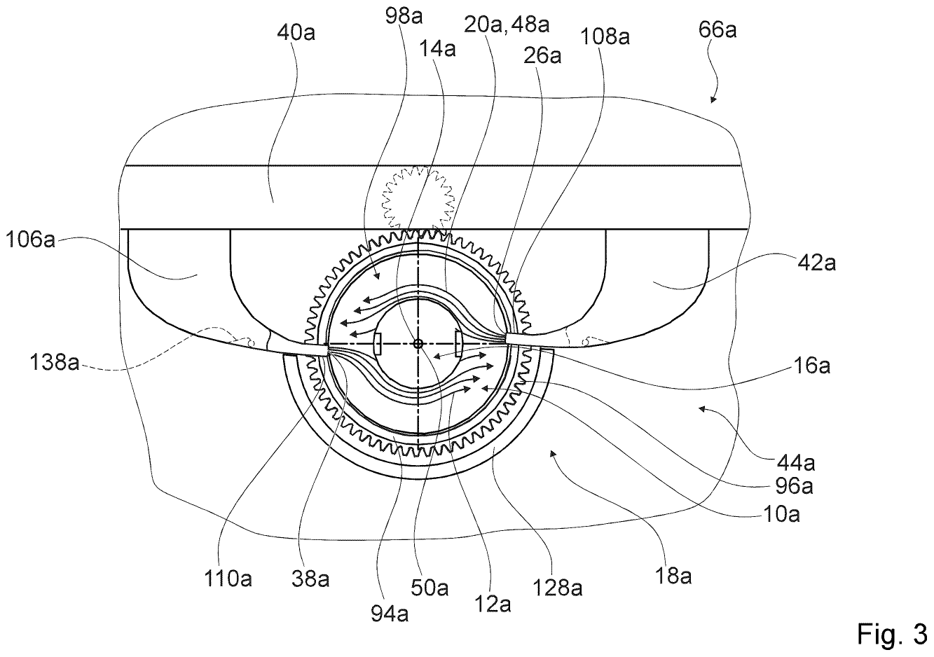

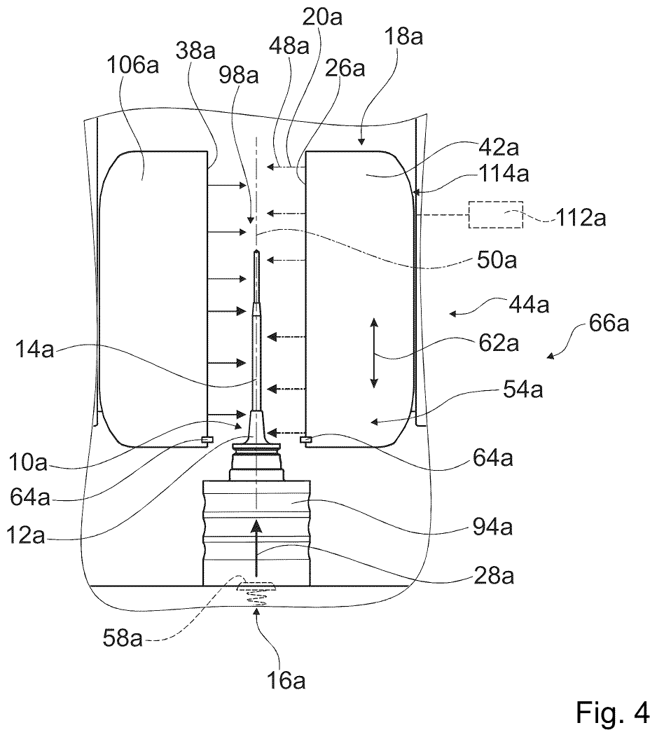

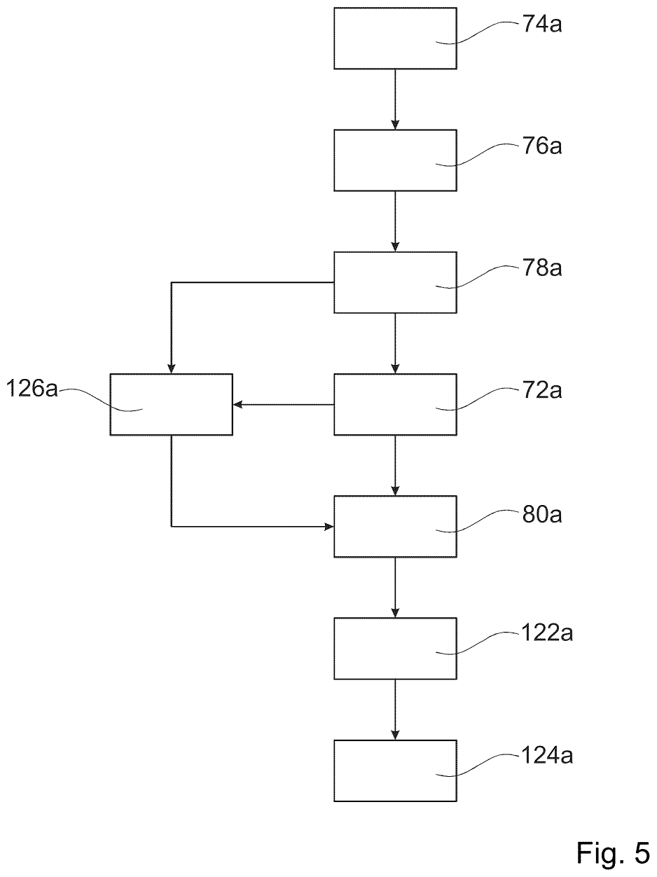

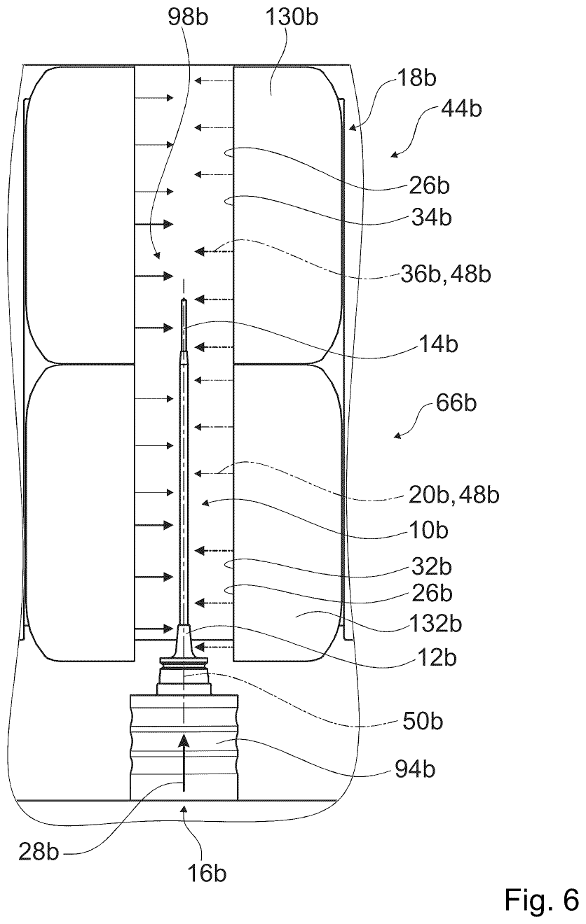

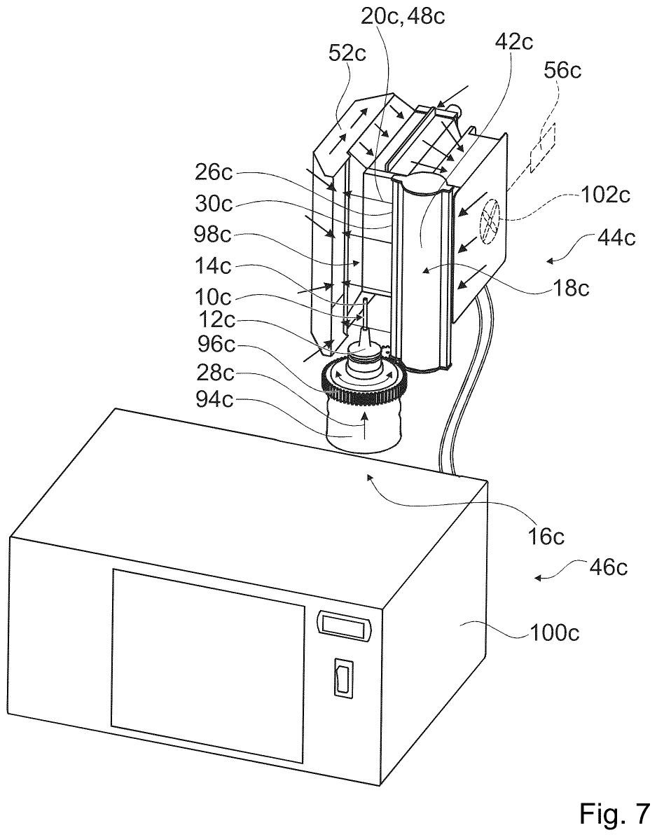

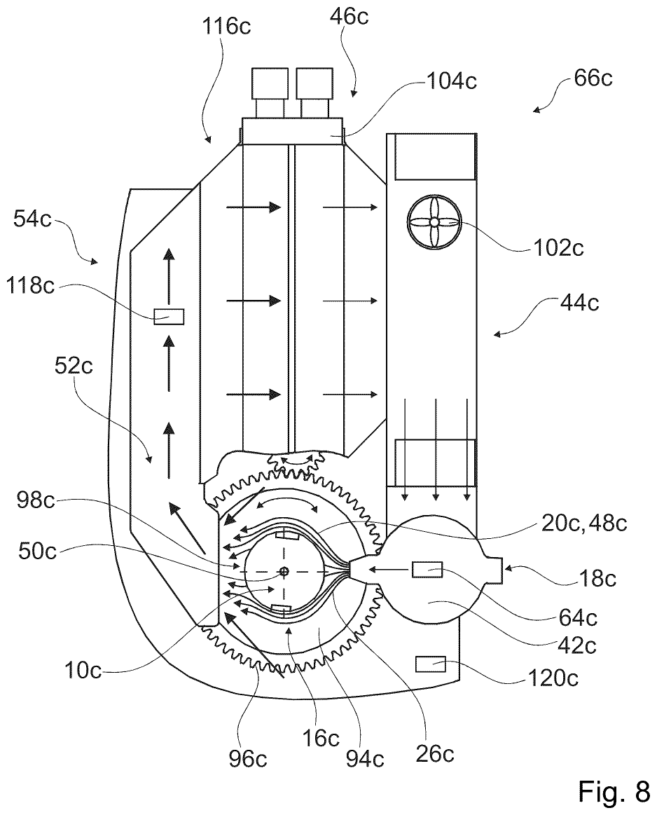

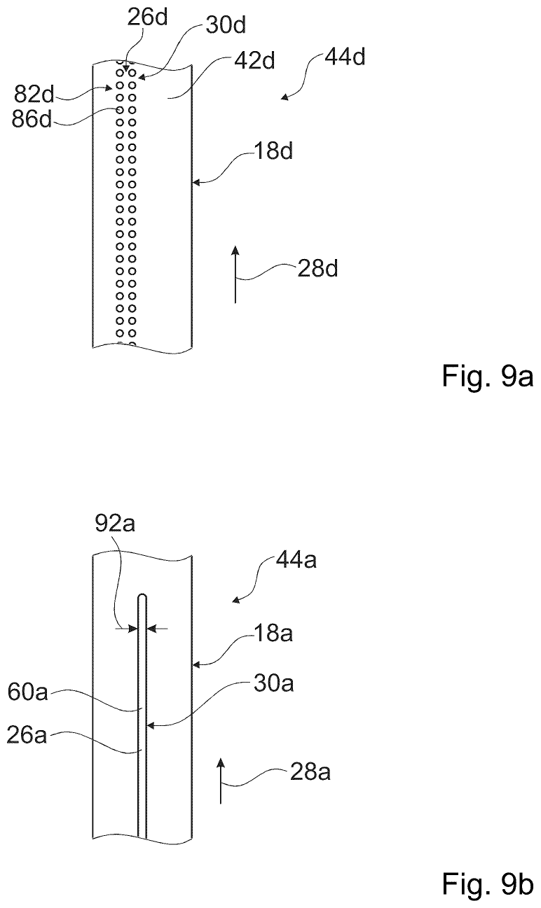

FIG. 9a shows a schematic view of a slot-shaped nozzle 26d of a cooling-gas nozzle unit 18d of a second alternative shrink-clamping gas cooling device 44d. The slot-shaped nozzle 26d of the cooling-gas nozzle unit 18d, which creates a cooling-gas flow 20d that forms a cooling gas knife, is realized as a strip-shaped arrangement 82d of a plurality of bores 86d. The bores 86d in each case have a diameter of maximally 0.5 mm. The strip-shaped arrangement 82d exemplarily shows two rows of bores 86d. Alternatively, a line-shaped arrangement 82d of the bores 86d along a single line or a strip-shaped arrangement 82d of the bores 86d along more than two rows or an irregular strip-shaped arrangement 82d of the bores 86d is also conceivable. The diameters of the bores 86d and a pressure of the cooling-gas nozzle unit 18d are selected in such a way that the cooling gas 48d exits the slot-shaped nozzle 26d/the bores 86d approximately with the velocity of sound.

FIG. 9b shows a schematic view of the slot-shaped nozzle 26a of the cooling-gas nozzle unit 18a of the shrink-clamping gas cooling device 44a, which was also described in the context of FIGS. 1 to 5. The slot-shaped nozzle 16a of the cooling-gas nozzle unit 18a, which generates a cooling-gas flow 20a that forms a cooling gas knife, is realized as a longitudinal-slot-shaped nozzle opening 60a. The longitudinal-slot-shaped nozzle opening 60a has a transverse extent 92a perpendicular to the installation direction 28a of maximally 3 mm, preferably no more than 1 mm. The slot-shaped nozzle 26a, in particular the longitudinal-slot-shaped nozzle opening 60a, forms the slot shape 30a. Alternatively, several nozzle openings 60a, arranged side by side and parallel to each other, are also conceivable.

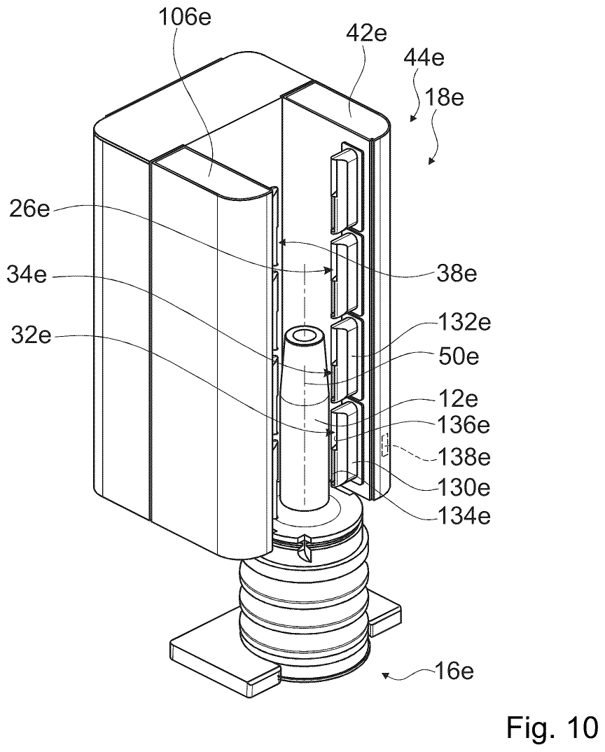

FIG. 10 shows a schematic view of a third alternative shrink-clamping gas cooling device 44e. The third alternative shrink-clamping gas cooling device 44e comprises a cooling-gas nozzle unit 18e. The cooling-gas nozzle unit 18e forms a slot-shaped nozzle 26e. The cooling-gas nozzle unit 18e is configured to create cooling-gas flows 20e, 36e, which form a cooling gas knife. The cooling-gas flows 20e, 36e are configured for a cooling of a previously heated region of a shrink-clamping chuck 12e. The cooling-gas nozzle unit 18e is configured to apply the cooling-gas flows 20e, 36e in a directed manner onto a tool unit 10e positioned in a cooling place 16e of the third alternative shrink-clamping gas cooling device 44e. The slot-shaped nozzle 26e has a first nozzle opening section 32e. The slot-shaped nozzle 26e has a second nozzle opening section 34e. The two nozzle opening sections 32e, 34e are assigned to nozzle section elements 130e, 132e of the slot-shaped nozzle 26e22 which are realized separately from each other. The separately realized nozzle section elements 130e, 132e are arranged one vertically above the other one. The slot-shaped nozzle 26e comprises at least the first nozzle section element 130e. The slot-shaped nozzle 26e comprises at least the second nozzle section element 132e. The first nozzle section element 130e and the second nozzle section element 132e are made of a transparent material. The first nozzle section element 130e and the second nozzle section element 132e are realized as one-piece injection-molded parts.

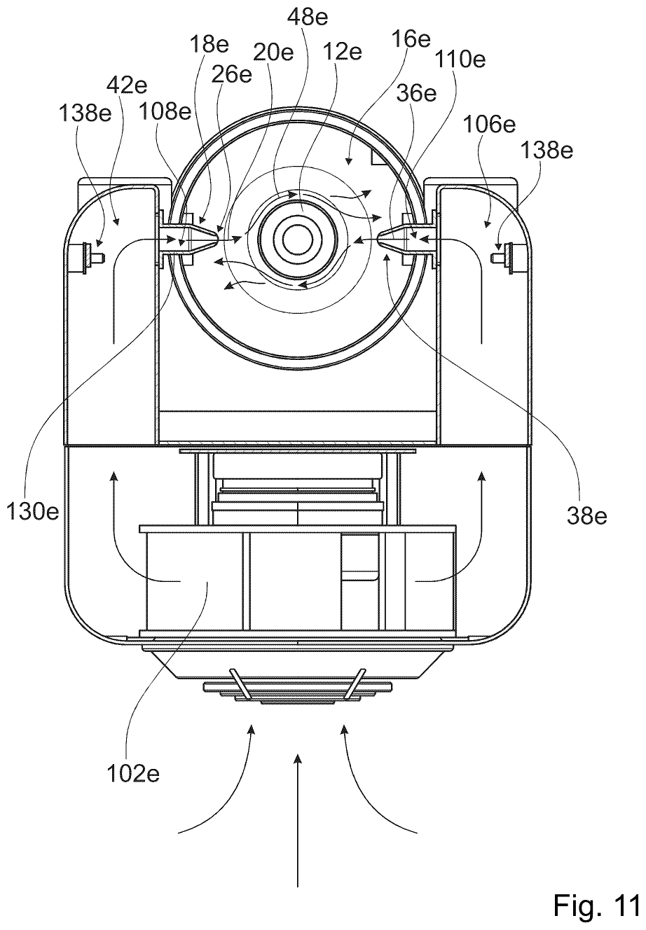

Each of the individual nozzle section elements 130e, 132e has two nozzle subregions 134e, 136e. The two nozzle subregions 134e, 136e of an individual nozzle section element 130e, 132e form subsections of the slot-shaped nozzle 26e which are oriented in directions that slightly differ from each other. In order to make use of the Coandă effect, the two nozzle subregions 134e, 136e of an individual nozzle section element 130e, 132e are in each case oriented offset from a central axis 50a of the cooling place 16e. The two nozzle subregions 134e, 136e of an individual nozzle section element 130e, 132e are oriented such that they point towards different sides of the central axis 50a of the cooling place 16e (see also FIG. 11). The third alternative shrink-clamping gas cooling device 44e comprises a first cooling gas conveying channel 42e. The third alternative shrink-clamping gas cooling device 44e comprises a second cooling gas conveying channel 106e. The nozzle section elements 130e, 132e are arranged/mounted at cooling-place-side ends 108e, 110e of the cooling gas conveying channels 42e, 106e. The third alternative shrink-clamping gas cooling device 44e comprises an illuminated display 138e. The illuminated display 138e is arranged in an interior of one of the cooling gas conveying channels 42e, 106e. The illuminated display 138e is configured to illuminate/make glow the (at least partly transparent) nozzle section elements 130e, 132e.

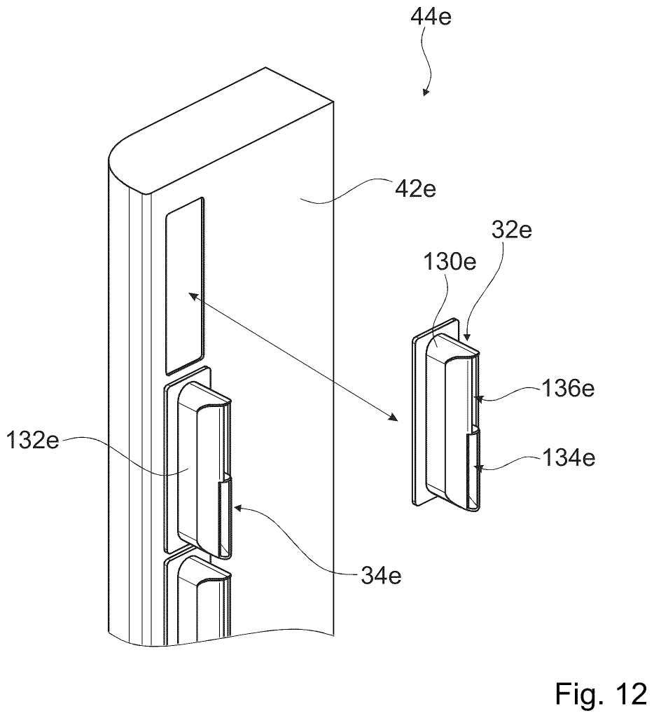

FIG. 12 shows a schematic detailed view of the third alternative shrink-clamping gas cooling device 44e with the nozzle section elements 130e, 132e. The nozzle section elements 130e, 132e are realized as separable components. The nozzle section elements 130e, 132e are realized as components which are non-destructively separable from the cooling gas conveying channels 42e, 106e. The nozzle section elements 130e, 132e are realized such that they are quick-action-wise exchangeable. The nozzle section elements 130e, 132e shown exemplarily in FIG. 12 are quick-action exchangeable via a magnetic coupling (not shown). For this purpose, mutually attracting permanent magnets (not shown) are arranged in the nozzle section elements 130e, 132e and in the cooling gas conveying channels 42e, 106e. The nozzle section elements 130e, 132e may moreover be selectively closable by (not shown) covers, which may for example be put over nozzle openings 60e of the nozzle section elements 130e, 132e.

Reference numerals

| | |
|---|---|
| 10 | tool unit |
| 12 | shrink-clamping chuck |
| 14 | tool |
| 16 | cooling place |
| 18 | cooling-gas nozzle unit |
| 20 | cooling-gas flow |
| 22 | longitudinal extent |
| 24 | longitudinal extent |
| 26 | slot-shaped nozzle |
| 28 | installation direction |
| 30 | slot shape |
| 32 | first nozzle opening section |
| 34 | second nozzle opening section |
| 36 | cooling-gas flow |
| 38 | second slot-shaped nozzle |
| 40 | basis |
| 42 | cooling gas conveying channel |
| 44 | shrink-clamping gas cooling device |
| 46 | tempering device |
| 48 | cooling gas |
| 50 | central axis |
| 52 | collecting unit |
| 54 | temperature sensor unit |
| 56 | control and/or regulation unit |
| 58 | occupancy detection device |
| 60 | nozzle opening |
| 62 | linear axis |
| 64 | temperature sensor |
| 66 | shrink-clamping station |
| 68 | cooling place |
| 70 | induction heating unit |
| 72 | method step |
| 74 | method step |
| 76 | method step |
| 78 | method step |
| 80 | method step |
| 82 | arrangement |
| 84 | display device |
| 86 | bore |
| 88 | heating station |
| 90 | cooling station |
| 92 | transverse extent |
| 94 | pot |
| 96 | toothing |
| 98 | cooling region |
| 100 | cooling apparatus |
| 102 | radial blower |
| 104 | heat exchanger |
| 106 | cooling gas conveying |
| 108 | end |
| 110 | end |
| 112 | drive unit |
| 114 | rail system |
| 116 | cooling-gas cycle |
| 118 | temperature sensor |
| 120 | temperature sensor |
| 122 | method step |
| 124 | method step |
| 126 | method step |
| 128 | flap |
| 130 | nozzle section element |
| 132 | nozzle section element |
| 134 | nozzle subregion |
| 136 | nozzle subregion |
| 138 | illuminated display |

1. A shrink-clamping gas cooling device, in particular a shrink-clamping air cooling device, at least for a cooling of tool units, each of which comprises at least one shrink-clamping chuck and at least one tool that is fixed in the shrink-clamping chuck, with at least one cooling place which is configured for receiving the tool unit, the shrink-clamping gas cooling device further comprising at least one cooling-gas nozzle unit, which is at least configured to apply a cooling-gas flow, in particular a cooling-air flow, which forms a cooling gas knife, in particular an air knife/air blade, directed onto the tool unit that is positioned in the cooling place.

2. The shrink-clamping gas cooling device according to claim 1, wherein the cooling-gas nozzle unit is configured to output the cooling-gas flow that forms the cooling gas knife, in particular simultaneously, along at least 80% of an entire longitudinal extent of the cooling place and/or along at least 80% of an entire longitudinal extent of any tool units which are regularly insertable in the cooling place.

3. The shrink-clamping gas cooling device according to claim 1, wherein the cooling-gas nozzle unit forms at least one slot-shaped nozzle, wherein a slot shape of the slot-shaped nozzle is aligned at least substantially parallel to a designated installation direction of the shrink-clamping chuck in the cooling place.

4. The shrink-clamping gas cooling device according to claim 3, wherein the slot-shaped nozzle has at least one first nozzle opening section and at least one second nozzle opening section, wherein at least the respective cooling-gas flows exiting said two nozzle opening sections can be activated and/or deactivated independently from each other.

5. The shrink-clamping gas cooling device according to claim 4, wherein the two nozzle opening sections are assigned to nozzle section elements of the slot-shaped nozzle which are realized separately from one another, in particular arranged vertically above one another.

6. The shrink-clamping gas cooling device according to claim 5, wherein the individual nozzle section elements are realized such that they are quick-action exchangeable and/or quick-action closable.

7. The shrink-clamping gas cooling device according to claim 1, wherein the cooling-gas nozzle unit forms at least one second slot-shaped nozzle, wherein a slot-shape of the second slot-shaped nozzle is aligned at least substantially parallel to the slot-shape of the slot-shaped nozzle.

8. The shrink-clamping gas cooling device according to claim 7, wherein the second slot-shaped nozzle is arranged on a side of the cooling place opposite the slot-shaped nozzle.

9. The shrink-clamping gas cooling device according to claim 3, wherein the slot-shaped nozzle and/or the second slot-shaped nozzle are/is arranged, in particular in each case, at an end of a cooling gas conveying channel of the shrink-clamping gas cooling device which is curved toward the cooling place and projects from a, preferably shared, basis.

10. The shrink-clamping gas cooling device according to claim 1, characterized by comprising a tempering device, which is configured to temper, preferably to cool, the cooling gas, in particular the cooling air.

11. The shrink-clamping gas cooling device according to claim 1, wherein the cooling place is configured for a rotatable support of the tool unit and/or of the shrink-clamping chuck.

12. The shrink-clamping gas cooling device according to claim 1, wherein the cooling place is configured for a support, translatable in a horizontal plane, of the tool unit and/or of the shrink-clamping chuck.

13. The shrink-clamping gas cooling device according to claim 1, wherein at least one slot-shaped nozzle of the cooling-gas nozzle unit is oriented—in particular in order to make use of the Coandă effect—offset from a central axis of the cooling place.

14. The shrink-clamping gas cooling device at least according to claim 4, wherein each of the individual nozzle section elements of the slot-shaped nozzle of the cooling-gas nozzle unit comprises at least two nozzle subregions, which are in each case—in particular in order to make use of the Coandă effect—oriented offset from the central axis of the cooling place, the two nozzle subregions of an individual nozzle section element being oriented so as to point towards different sides of the central axis of the cooling place.

15. The shrink-clamping gas cooling device according to claim 1, comprising a collecting unit for used cooling gas.

16. The shrink-clamping gas cooling device according to claim 1, characterized by comprising a temperature sensor unit, which is at least configured to register a temperature difference between an initial temperature of the cooling gas before a contact with the tool unit and/or the shrink-clamping chuck and an end temperature of the cooling gas after the contact with the tool unit and/or the shrink-clamping chuck.

17. The shrink-clamping gas cooling device according to claim 16, comprising a control and/or regulation unit, which is at least configured to adjust, in particular in an automated manner, a cooling duration and/or a cooling gas temperature on the basis of a room temperature measurement, on the basis of a measurement of an end temperature of the cooling gas after the contact with the tool unit and/or with the shrink-clamping chuck and/or on the basis of a measurement of a temperature difference between an initial temperature of the cooling gas before a contact with the tool unit and/or with the shrink-clamping chuck and the end temperature of the cooling gas after the contact with the tool unit and/or with the shrink-clamping chuck.

18. The shrink-clamping gas cooling device according to claim 1, wherein the cooling place comprises an occupancy detection device, which is configured for an automated recognition of an occupancy situation of the cooling place.

19. The shrink-clamping gas cooling device according to claim 1, wherein the cooling-gas nozzle unit or at least one slot-shaped nozzle of the cooling-gas nozzle unit is realized so as to be traversable along a linear axis, which in particular extends at least substantially parallel to a designated installation direction of the shrink-clamping chuck.

20. The shrink-clamping gas cooling device according to claim 1, comprising at least one temperature sensor for determining an instantaneous temperature of at least one section of the shrink-clamping chuck-positioned in the cooling place or of the tool unit-positioned in the cooling place.

21. The shrink-clamping gas cooling device according to claim 19, comprising at least one temperature sensor for determining an instantaneous temperature of at least one section of the shrink-clamping chuck positioned in the cooling place or of the tool unit positioned in the cooling place, and wherein the temperature sensor can be moved along with the linearly movable cooling-gas nozzle unit or with the linearly movable slot-shaped nozzle.

22. The shrink-clamping gas cooling device according to claim 20, wherein the temperature sensor is configured to detect a position of a hot section at least of the shrink-clamping chuck or of the tool unit.

23. The shrink-clamping gas cooling device according to claim 22, wherein a positioning of a linearly movable cooling-gas nozzle unit or of a linearly movable slot-shaped nozzle or an activation of one or several nozzle opening sections of the slot-shaped nozzle is controlled depending on the determined position of the hot section of the shrink-clamping chuck or of the tool unit identified by the temperature sensor.

24. The shrink-clamping gas cooling device according to claim 1, wherein the cooling-gas nozzle unit, in particular the slot-shaped nozzle(s) of the cooling-gas nozzle unit which create the cooling-gas flow that forms the cooling gas knife, is/are realized as a line-shaped or stripe-shaped arrangement of a plurality of bores having a diameter of less than 1 mm, preferably of maximally 0.5 mm.

25. The shrink-clamping gas cooling device according to claim 1, comprising an illuminated display, which is assigned to the cooling-gas nozzle unit, for indicating a progress and/or a state of a current cooling process of a tool unit that is situated in a cooling place.

26. The shrink-clamping gas cooling device according to claim 25, wherein the illuminated display is arranged in an interior of a cooling gas conveying channel of the cooling-gas nozzle unit and is configured to illuminate/make glow at least one slot-shaped nozzle, in particular at least one, preferably at least section-wise transparent, nozzle section element of the slot-shaped nozzle.

27. A shrink-clamping station with a shrink-clamping gas cooling device according to claim 1.

28. The shrink-clamping station-according to claim 27, comprising a plurality of separately loadable cooling places.

29. The shrink-clamping station according to claim 27, comprising an induction heating unit.

30. (canceled)

31. A method for a cooling of tool units and/or shrink-clamping chucks with at least one shrink-clamping gas cooling device according to claim 1, wherein in at least one method step, at least on the basis of a composition of a tool unit that is currently to be cooled/on the basis of a type of a shrink-clamping chuck that is currently to be cooled, and/or on the basis of shrink-clamping parameters used in a preceding shrink-clamping process of the tool unit that is currently to be cooled or of the shrink-clamping chuck that is currently to be cooled, an optimal cooling time is determined, preferably in an automated manner.

32. A shrink-clamping method for a clamping-in of tools into shrink-clamping chucks and/or for a removal of tools out of shrink-clamping chucks, wherein in one method step the shrink-clamping chuck is heated such that a receiving space of the shrink-clamping chuck expands, wherein in a further method step the tool is inserted into the expanded receiving space of the shrink-clamping chuck so as to form a tool unit, or the tool is removed from the expanded receiving space of the shrink-clamping chuck, and wherein in a further method step the hot tool unit or the hot shrink-clamping chuck is inserted into a cooling place of a shrink-clamping station, in particular according to claim 27, wherein in a further method step the tool unit, in particular the entire tool unit, or the shrink-clamping chuck, in particular the entire shrink-clamping chuck, is cooled by a cooling-gas flow, in particular cooling-air flow, which forms a cooling gas knife, in particular an air knife/air blade, and which is directed to the tool unit positioned in the cooling place or to the shrink-clamping chuck positioned in the cooling place.
